(19) United States
(12) Patent Application Publication
(10) Pub. No.: US 2006/0292440 A1
(43) Pub. Date: Dec. 28, 2006

(54) Portable power supply unit

(76) Inventor: Robert Levine, Delray Beach, FL (US)

Correspondence Address: BERND W. SANDT, 900 DEERFIELD COURT, MIDLAND, MI, 48640, US

(21) Appl. No.: 11/349,390

(22) Filed: Feb. 7, 2006

Related U.S. Application Data
(60) Provisional application No. 60/694,286, filed on Jun. 27, 2005.

(51) Int. Cl. H01M 2/10

(52) U.S. Cl. 429/99; 429/123

(57) ABSTRACT

A portable power supply unit having in combination, a supporting box having a cavity arranged for receiving two batteries, two electric batteries removably disposed in said cavity, a cover to securely contain such batteries in said box, solid embedded circuits electrically contacting said batteries in either parallel or series voltage contained with in the box, and means for accessing the current from outside the box.

The present invention relates to a power supply unit and more particularly to a portable hand held unit that is useful to supply electrical power to a variety of electronic and electric equipment. The present application is a continuation in part of copending provisional application 60/694,286 filed Jun. 27, 2005.

### FIELD OF THE INVENTION

### Background of the Invention

A variety of different portable power supplies are currently available. By having an independent portable unit it is possible to power a variety of electronic and electric equipment that uses a direct battery current. Such power supply units are generally suitable for only one type of current and frequently contain wiring that makes replacement of the batteries of the power unit awkward and can readily result in loss of contact or breach in the circuitry. Furthermore such wiring requires extra space and thus makes the power unit less rugged. There is a need for a compact, rugged, readily portable power supply that can withstand the impact occurring in activities such as camping, hiking and climbing and that can power a variety of electric and electronic equipment. The power supply units of the present invention are furthermore useful in emergency situations such as power outages caused by hurricanes, floods, tornados and other natural and man-made disasters.

### SUMMARY OF THE INVENTION

The present invention provides a portable handheld power supply that is based on the use of batteries having both terminals in the same plane. A prime example of such battery is the standard 6-volt lantern battery. The batteries when exhausted are readily replaceable and do not require any fastening of wires to the terminals. The power unit basically comprises the box containing the batteries such that they are held in place by the walls of the box. and a cover for the box which can be hinged to the box or snap fit tightly on the box. The cover should be attached to the box in such a way that it will resist opening when accidentally subjected to impact. The size of the box is adjusted such that at least one side of the box or the cover is in contact with the terminals of the battery. The cover contains a handle for carrying the power supply.

The interior of the box contains embedded solid circuitry that allows the current of the batteries to flow either in series or in parallel to the handle. The handle is in electrical contact with the batteries through solid circuits embedded on the inside surfaces of the box and contains the outlets that allows the current to flow to a variety of electronic or electrical equipment such as computers, radios, telephones, television sets, tape or CD players, tools or lights. In one embodiment of the present invention circuits can be embedded on one or both sides of the cover such that one side the handle is in contact with the circuit connecting the batteries in parallel and when the cover is reversed the handle is in contact with the circuit connecting the batteries in series. In the case of a power supply unit using two lantern batteries one side causes the batteries to be used in parallel and give to a current of 6 volt whereas the other side causes the batteries to be used in series and thus would give rise to a current of 12. The handle is in this embodiment the handle is reversibly attached to the cover.

In the alternative one electrical circuit can be on the underside of the cover and the other on the bottom of the box. The bottom of the box should then contain the holes necessary to attach the handle and establish the electrical contact with the battery to supply 12 volt current. The batteries are then inserted into the box up side down to establish the alternate voltage. The box is constructed in such a way that the batteries are in contact with the solid circuitry on the cover or on the bottom of the box to establish a good contact with the outlets in the handle. The box, cover and handle can be constructed of a suitably rigid non-conductive plastic of sufficient impact resistance, such as ABS, used in housing of appliances or wood. In an alternative embodiment, instead of containing female receptacles the power pack can be equipped with male plugs that can be connected to a variety of electronic and electric equipment.

In another embodiment of the invention the printed circuits are located on a board that can be inserted into the box and is in electrical contact with the batteries and the handle on the outside cover of the box. One side of the board provides solid circuits embedded in the board for the batteries to operate in series and the other side provides the solid circuits to operate the batteries in parallel.

### BRIEF DESCRIPTION OF THE DRAWING

FIG. 1 is a perspective schematic view of the battery container and the cover with the handle attached.

FIG. 2 is a perspective schematic view of the battery container showing the embedded solid circuitry on the underside of the cover.

FIG. 3 shows the two embedded circuits when using the batteries either in series or in parallel arrangement. This figure also shows the two sides of a rectangular board that can be inserted into the container.

FIG. 4 is a perspective schematic view of the use the power pack of the present invention with positive plugs, which allows for connection to other equipment.

### DETAILED DESCRIPTION OF THE PREFERRED EMBODIMENT

In the preferred embodiment of the present invention the portable power unit employs two lantern batteries of 6 volts each and the invention is principally described in the terms of such batteries. It is to be understood however that the features of the present invention can be employed with other batteries and thus the description is not intended be limiting.

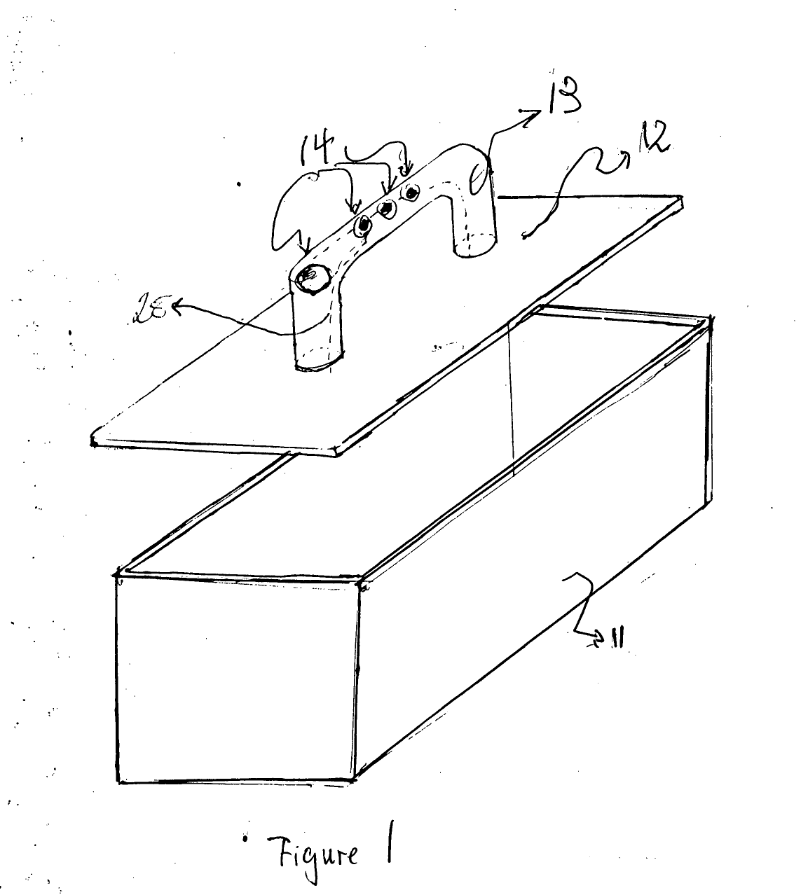

Referring now more particularly to FIGS. 1 through 4, the portable power package of the present invention has a box 11 constructed in such a way as to securely contain the batteries to be employed in the power pack. Although the batteries should fit snuggly they should not fit so tightly that they cannot be readily slid out of the box for replacement. The size of the box is adjusted in its dimensions and particularly its height so as to allow electrical contact with the cover 12 that is either hinged to the box (not shown) or can be attached firmly to the box by a snap fit. Sufficient electrical contact can also be achieved by inserting removable springs in the bottom of the box Obviously the terminals of the batteries should be in such a form as to allow contact with the solid circuits in the cover or the base. The cover is equipped with a removable handle 13 that is in electrical contact by wiring 28 contained in the handle with the circuitry on the inside of the cover, which in turn is in contact with the batteries. In that connection the bolts or rivets employed to attach the handle to the cover can be suitably employed to conduct the current from the interior of the box to the handle. The handle contains a variety of female electrical receptacles 14 to accommodate a variety of electrical and electronic equipment. Instead of a female plug the handle may also be constructed with a retractable male plug attached to an electrical cord. The length of the handle can be adjusted to create the terminals for the circuit.

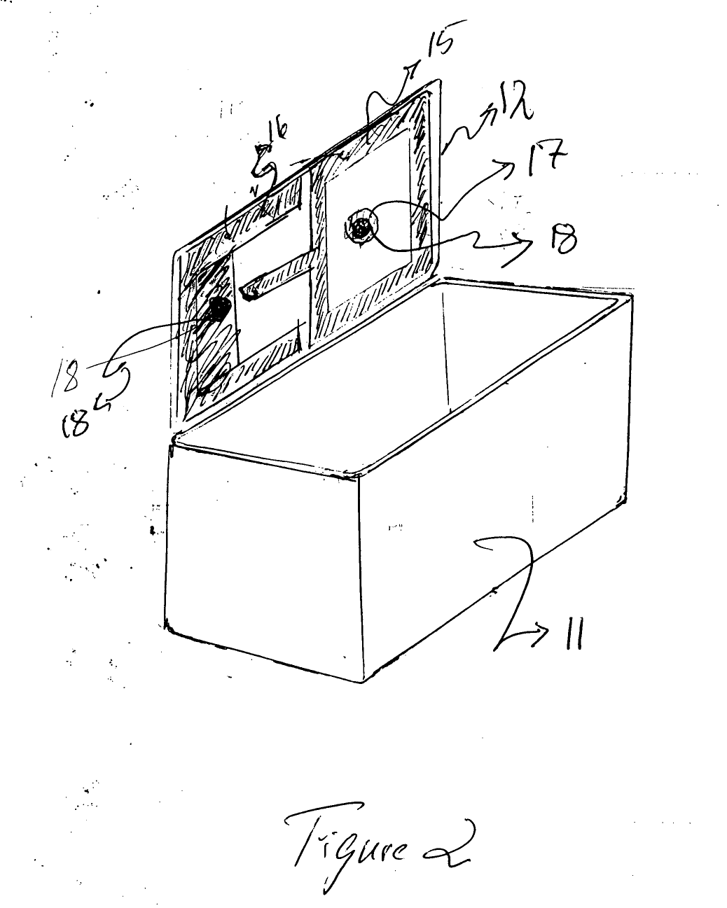

In FIG. 2 the same box 11 is shown with the cover 12 hinged and pivotally mounted to the box and also showing the electrical circuits 15, 16 and 17 on the -underside of the cover. The technology for creating electrically conducting surfaces is well known and can be as simple as adhering metallic foil to the surface, or applying electric or vapor deposition on the surface of the cover. The handle is attached to the cover by rivets 18 or other means on the underside of the cover where it is in electrical contact with the circuit on the underside of the cover. As shown the two batteries when inserted into the container will give rise to a current of 12 volts that can be accessed through the handle containing a receptacle similar to those that are used in cigarette lighter plugs in an automobile. Whereas the electrical connection at 17 connects to the negative pole of the second battery circuit 16 connects to the positive pole of the first battery and circuit 15 interconnects the two batteries

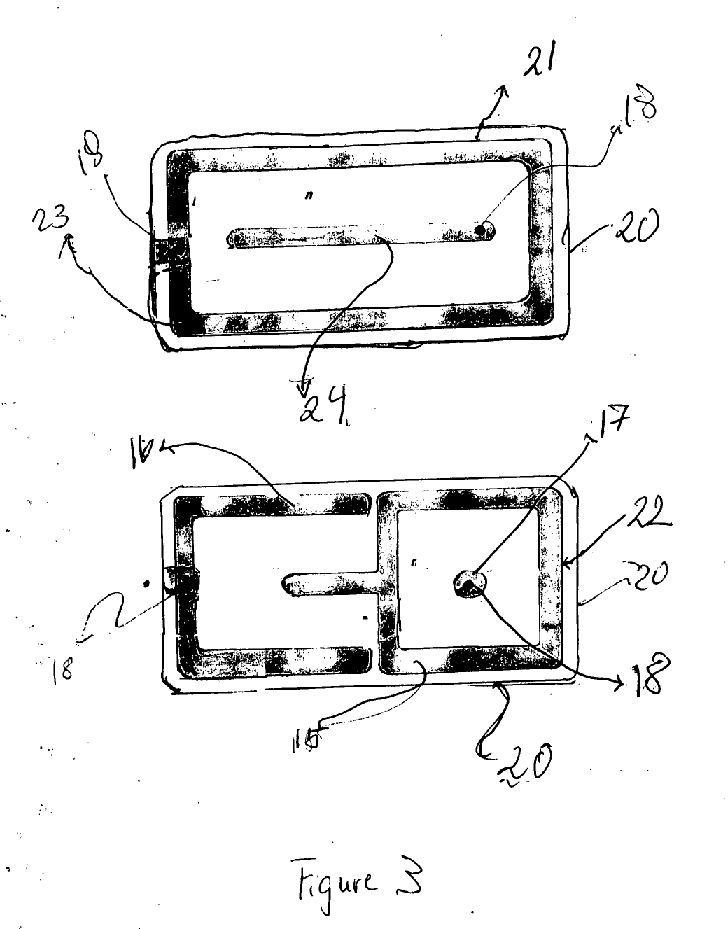

In FIG. 3 two different embedded circuits 21 and 22 are shown which result in either a 6-volt or a 12-volt current. The two circuits can be embedded on the surfaces of a board, which constitutes another embodiment of the present invention The circuit board is of the size to fit on the base of the box containing the batteries or under the cover. The circuit boards comprise a non-conducting rigid substrate 20 on which are deposited the circuit for the six, 21, and twelve, 22, volt current. The non-conducting board is preferably not more than 0.25 in thickness and can be made from cardboard, laminated wood, plastic or plastic foam. For the six-volt embedded circuit 21, the positive circuit and connection to the handle through bolt or rivet 18 is provided by circuit 23 and the negative circuit and connection to the handle through bolt 18 is provided by circuit 24. The circuitry for the twelve-volt connection is the same as shown in FIG. 1. The board and the handle are attached to either the underside of the cover or to the upper side of the bottom by means of rivets 18. It is to be understood that instead of using a circuit board the same circuits can be deposited on the underside of the cover and the bottom of the box containing the batteries.

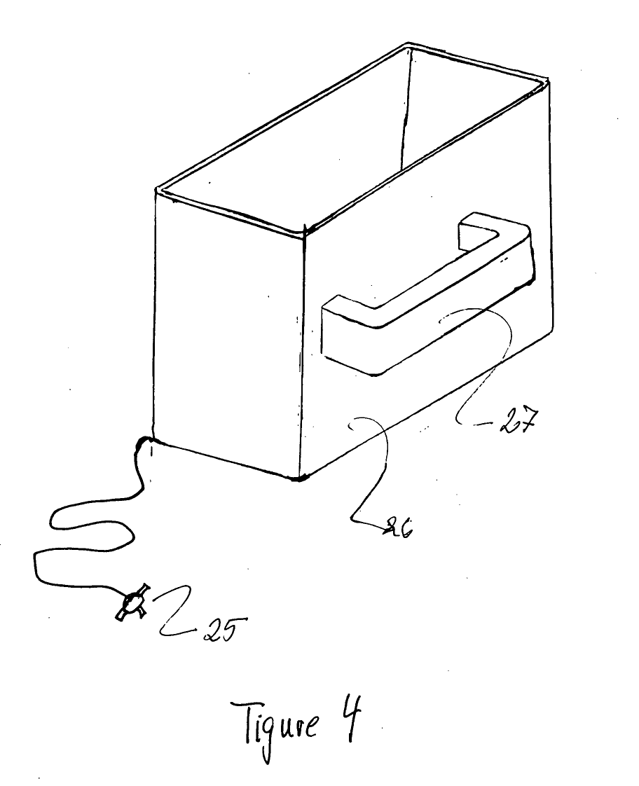

FIG. 4 demonstrates an embodiment of the present invention that does not rely on the handle to provide the connection between the battery and the electric or electronic equipment to be used. Thus instead of being available through a handle the current of the batteries can be used through jacks 25, which are wired to the printed circuits contained within the box 26 and in contact with the batteries in the box. A handle 27 can be attached at a position most convenient for use of the power pack.

The foregoing detailed description is not intended to limit the scope of this invention and various modifications of the basic principles will be apparent to those skilled in the art. Thus solid circuitry can be adapted to accommodate batteries where the terminals are not located in the same plane.

1. A portable power supply unit having in combination
a. a supporting box having a cavity arranged for receiving two batteries
b. two electric batteries removably disposed in said cavity,
c. a cover to securely contain such batteries in said box,
d. solid embedded circuits electrically contacting said batteries in either parallel or series voltage contained with in the box, and
e. means for accessing the current from outside the box.

2. The portable power supply unit of claim 1 wherein the solid circuits are contained or, he base or under the cover of the box.

3. The portable power supply of claim 2 wherein the means of accessing the current from outside the box comprise a removable handle for said box containing electric outlets, said outlets being in electrical contact through the handle with the solid circuits inside the box.

4. The portable power supply of claim 2 wherein the solid circuits are part of the underside of the cover or the surface of the base of the box.

5. The portable power supply of claim 1 wherein the batteries are two six-volt lantern batteries.

6. The portable power supply of claim 1 wherein the means of accessing the solid circuits are by independent outlets connected through wiring to the solid circuits inside the box.

7. The power supply unit of claim 1 wherein the circuits are embedded on on the surface of an independent rigid board insertable into the box.
